(19) United States
(12) Patent Application Publication
(10) Pub. No.: US 2017/0179767 A1
(43) Pub. Date: Jun. 22, 2017

(54) COIL ASSEMBLY AND WIRELESS POWER TRANSMISSION SYSTEM

(71) Applicant: Industrial Technology Research Institute, Hsinchu (TW)

(72) Inventors: Li-Chi Chang, Taichung City (TW); Meng-Sheng Chen, Kaohsiung City (TW); Hsun Yu, Hsinchu County (TW)

(73) Assignee: Industrial Technology Research Institute, Hsinchu (TW)

(21) Appl. No.: 15/286,589

(22) Filed: Oct. 6, 2016

(30) Foreign Application Priority Data
Dec. 21, 2015 (TW) 104142899

(51) Int. Cl. H02J 50/12; H01F 27/28

(52) U.S. Cl. CPC H02J 50/12; H01F 27/28

(57) ABSTRACT

A coil assembly and a wireless power transmission system are provided. The coil assembly includes a first coil and a second coil. The first coil is disposed on a first plane. The second coil is disposed on a second plane. The second coil is coupled to the first coil. The second coil includes a plurality of bending section, and the bending sections are connected by a plurality of connection lines to form a single loop.

### CROSS-REFERENCE TO RELATED APPLICATION

This application claims the priority of Taiwan application serial no. 104142899, filed on Dec. 21, 2015. The entirety of the above-mentioned patent application is hereby incorporated by reference herein and made a part of this specification.

### TECHNICAL FIELD

The disclosure relates to a coil assembly and a wireless power transmission system.

### BACKGROUND

In recent years, electronic products applying wireless power transmission become more and more diversified, and power exchange is implemented by using a time-varying magnetic field between coil assemblies, so that it is important to improve the efficiency of electromagnetic induction. Generally, four independent coils construct a wireless power transmission system via magnetic resonance. Two of the independent coils construct a transmitter and may respectively serve as a driving coil and a transmitting coil; the other two independent coils construct a receiver and may respectively serve as a receiving coil and a load coil. The driving coil induces an electromotive force (emf) on the transmitting coil through inductive coupling; then the power is transmitted by magnetic resonance between the transmitting coil and the receiving coil, and then the receiving coil also induces an emf on the load coil through inductive coupling, so that the wireless power transmission system may transmit electric power from the driving coil to the load coil.

According to the Biot-Savart law, magnetic field strength decreases with the distance departing from a wire which carries steady current. Therefore, the magnetic field strength may be uneven in the region encircled by traditional round coils. For example, the magnetic field is relatively strong in the position which is close to the coil and is relatively weak in the center of the region encircled by the coil. This phenomenon may degrade the efficiency of the wireless power transmission system.

### SUMMARY

The disclosure provides a coil assembly including a first coil and a second coil. The first coil is disposed on a first plane. The second coil is disposed on a second plane. The second coil is coupled to the first coil. The second coil includes a plurality of bending sections, and the bending sections are connected by a plurality of connection lines to form a single loop.

The disclosure provides a wireless power transmission system including a first coil assembly and a second coil assembly. The first coil assembly includes a first coil and a second coil. The second coil assembly includes a third coil and a fourth coil, and the first coil assembly is coupled to the second coil assembly. At least one of the second coil and the fourth coil include a plurality of bending sections, and the bending sections are connected by a plurality of connection lines to form a single loop.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a circuit diagram of a coil assembly according to an embodiment of the disclosure.

FIG. 2A to FIG. 2C are schematic diagrams of a coil assembly according to an embodiment of the disclosure.

FIG. 3 is a schematic diagram of a coil assembly according to another embodiment of the disclosure.

FIG. 4A to FIG. 4C are schematic diagrams respectively illustrating coils with different number of fan-shaped bending sections according to an embodiment of the disclosure.

FIG. 5A to FIG. 5D are schematic diagrams respectively illustrating coils with different number of leaf-shaped bending sections according to an embodiment of the disclosure.

FIG. 6A is a schematic diagram of a coil with a rectangular pattern according to another embodiment of the disclosure.

FIG. 6B is a schematic diagram of a coil with a serrated pattern according to another embodiment of the disclosure.

FIG. 7 is a schematic diagram of a wireless power transmission system according to an embodiment of the disclosure.

FIG. 8A is a schematic diagram illustrating a configuration of coils of a wireless power transmission system according to an embodiment of the disclosure.

FIG. 8B is a side view of the wireless power transmission system of FIG. 8A according to an embodiment of the disclosure.

FIG. 8C is a side view of the wireless power transmission system of FIG. 8A according to another embodiment of the disclosure.

FIG. 9A is a schematic diagram illustrating a configuration of coils of a wireless power transmission system according to an embodiment of the disclosure.

FIG. 9B is a side view of the wireless power transmission system of FIG. 9A according to an embodiment of the disclosure.

FIG. 9C is a side view of the wireless power transmission system of FIG. 8A according to another embodiment of the disclosure.

### DESCRIPTION OF EMBODIMENTS

A plurality of embodiments is provided below to describe the disclosure in detail, though the disclosure is not limited to the provided embodiments, and the provided embodiments can be mutually combined, suitably.

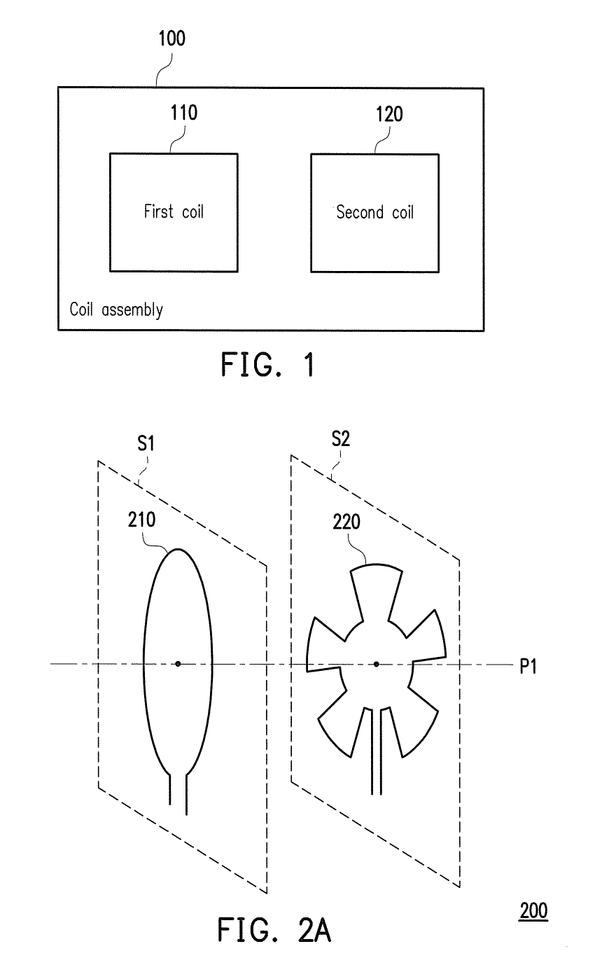

FIG. 1 is a circuit diagram of a coil assembly according to an embodiment of the disclosure. The coil assembly 100 includes a first coil 110 and a second coil 120. Wireless energy is transmitted between the first coil 110 and the second coil 120 through coupling, for example, inductive coupling. The coil assembly 100 can be connected to a driving circuit (not shown) or a load circuit (not shown) for power transmitting or receiving, as designed.

The coil assembly 100 provided in the embodiment may serve as a transmitting end of a wireless power transmission device. The coil assembly 100 can be connected to a driving circuit (not shown) through one of the first coil 110 and the second coil 120, and transmits energy provided by the driving circuit to another receiving device in a wireless transmission manner. Alternatively, the coil assembly 100 of the embodiment may also serve as a receiving end of the wireless power transmission device. The coil assembly 100 can be connected to a load circuit (not shown) through one of the first coil 110 and the second coil 120, and transmits the received energy to the load circuit in a wireless transmission manner.

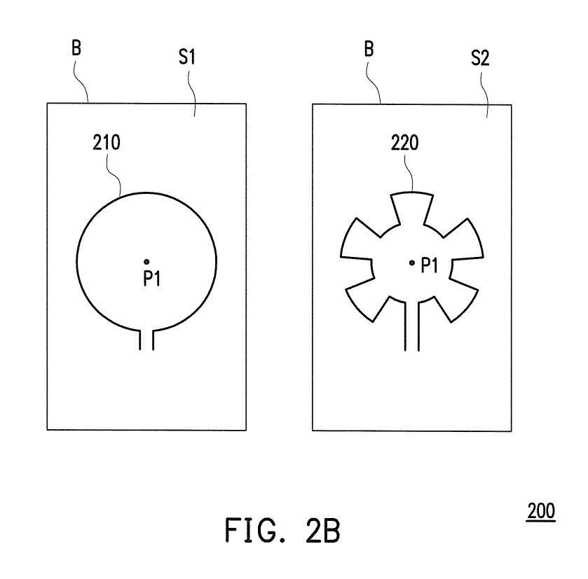

FIG. 2A to FIG. 2C are schematic diagrams of a coil assembly according to an embodiment of the disclosure. Referring to FIG. 2A, the coil assembly 200 shown in FIG. 2A includes a first coil 210 and a second coil 220. The first coil 210 is disposed on a first plane S1 of a substrate B, the second coil 220 is disposed on a second plane S2 of the substrate B, and the first plane S1 is parallel to the second plane S2. A coil pattern of the first coil 210 is round, and a coil pattern of the second coil 220 is a plurality of arranged fan-shaped patterns.

For example, referring to FIG. 2B, in the embodiment, the first coil 210 and the second coil 220 of the coil assembly 200 can be respectively disposed on the first plane S1 and the second plane S2 of the substrate B, where the first plane S1 is not coincident with the second plane S2, and central axes of the first coil 210 and the second coil 220 are coincident with a central axis P1. The central axis P1 is perpendicular to the first plane S1 and the second plane S2. In other words, there is a distance between the first plane S1 and the second plane S2, and the first plane S1 is not intersected with the second plane S2. Therefore, the first coil 210 and the second coil 220 are parallel to and not coincident with each other. In the embodiment, the substrate B can be any carrier medium or material that is suitable for setting coils, such as a printed circuit board (PCB), a flexible printed circuit board (FPC), an integrated circuit board (thin-film), etc., and a thickness of the substrate B can be designed according to different coil sizes, materials, magnetic coupling ranges, etc., which is not limited by the disclosure. In an embodiment, the first coil 210 may have a round pattern.

Moreover, referring to FIG. 2C, in the embodiment, the second coil 220 includes a plurality of bending sections 221-225, and the bending sections 221-225 are connected by a plurality of connection lines 226 to form a single loop. The bending sections 221-225 are respectively disposed along a round track for corresponding to the round coil pattern of the first coil 210 shown in FIG. 2A. Moreover, the bending sections 221-225 include a plurality of bending patterns, and theses bending patterns are, for example, curved lines or straight lines and are arranged in a fan-shaped manner. The bending sections 221-225 are connected to each other by the connection lines 226. In the embodiment, the bending patterns of the bending sections 221-225 may be identical or different, which is not limited by the disclosure.

In the embodiment, the second coil 220 may include a plurality of the bending sections with the same fan-shaped pattern. Through the bending sections extending to the coil center, the second coil 220 may provide a magnetic field in which the strength is evenly distributed. In this way, the inductive coupling between the first coil 210 and the second coil 220 may have good energy transmission efficiency.

Moreover, in the embodiment, the distance between the first coil 210 and the second coil 220 is not limited by the disclosure. Sizes of the first coil 210 and the second coil 220 of the embodiment can be determined according to an actual design requirement, and the distance between the first coil 210 and the second coil 220 is determined according to the sizes of the first coil 210 and the second coil 220. In another embodiment, the first coil 210 and the second coil 220 may have the same pattern or different patterns, and the first coil 210 and the second coil 220 may have different sizes, which are not limited by the disclosure.

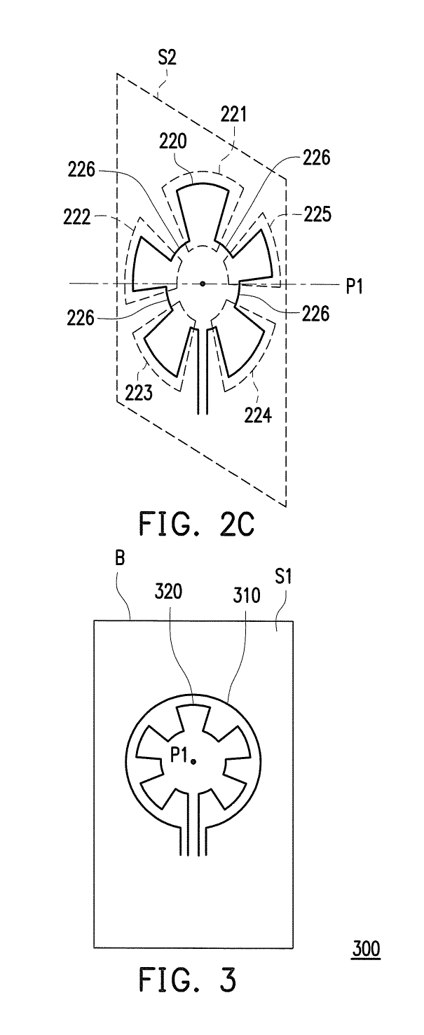

Referring to FIG. 3, a schematic diagram of a coil assembly is shown according to another embodiment of the disclosure. The coil assembly 300 includes a third coil 310 and a fourth coil 320, and the third coil 310 and the fourth coil 320 can be both disposed on the same plane of the substrate B. In an embodiment, the third coil 310 and the fourth coil 320 are both disposed on the same plane of the substrate B, for example, a first plane S1. A difference between the coil assembly 300 shown in FIG. 3 and the coil assembly 200 shown in FIG. 2 is that the third coil 310 and the fourth coil 320 are both disposed on the same plane and have the same central axis P1. The central axis P1 is perpendicular to the first plane S1. In the embodiment, the distance between the central axis P1 and any point on the third coil 310 is greater than the distance between the central axis P1 and any point on the fourth coil 320. Therefore, the third coil 310 surrounds the fourth coil 320. Moreover, in another embodiment, the third coil 310 and the fourth coil 320 can be both disposed on the second plane S2.

In the embodiment, since the fourth coil 320 has a plurality of bending sections with the same fan-shaped pattern, the fourth coil 320 may provide a magnetic field with the evenly distributed strength through the bending sections extending to the coil center. Therefore, the inductive coupling between the third coil 310 and the fourth coil 320 may have good energy transmission efficiency.

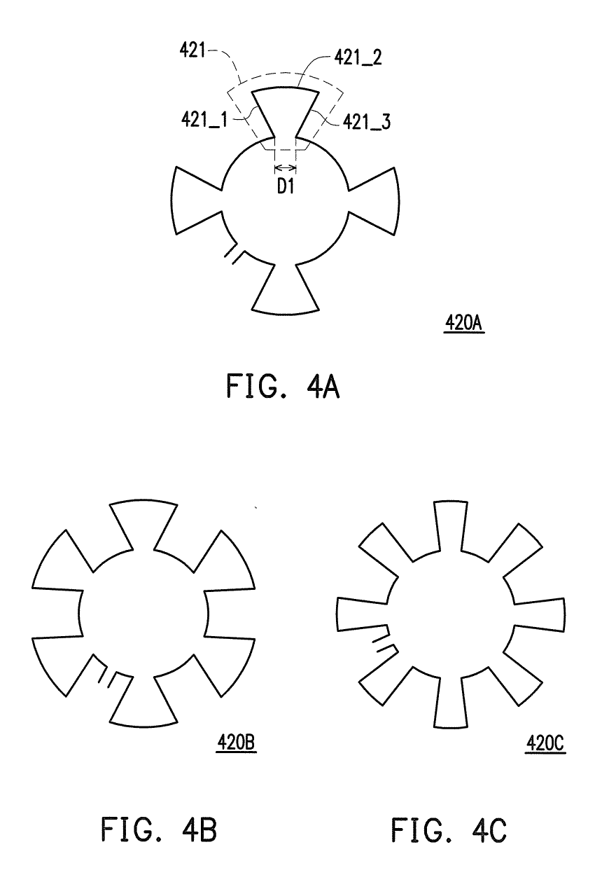

In the aforementioned embodiments, the number of the bending sections of the coil is not limited to the coil structures shown in FIG. 2 and FIG. 3. The number of the bending sections of the coil provided in the disclosure can be determined according to an actual design requirement. For example, FIG. 4A to FIG. 4C are schematic diagrams respectively illustrating coils with different number of fan-shaped bending sections according to an embodiment of the disclosure. In FIG. 4A to FIG. 4C, the coils 420A-420C respectively have four, six, and eight bending sections, where the bending sections all have the same fan-shaped bending pattern. Through a part of the bending sections extending to the coil center, the coils 420A-420C can provide more evenly distributed magnetic field strength than traditional round coils in the region encircled by the coils, so as to provide good wireless transmission efficiency.

Referring to FIG. 4A, in the embodiment, the coil 420A has four bending sections, and each of the bending sections has the same fan-shaped bending pattern. In an embodiment, the bending section 421 has a first section 421_1, a second section 421_2, and a third section 421_3, where the second section 421_2 is connected to one end of the first section 421_1 and one end of the third section 421_3, and a length of the second section 421_2 is greater than a distance D1 between the other end of the first section 421_1 and the other end of the third section 421_3. Pattern characteristics of the other bending sections of the coil 420A are similar to those of the bending section 421. Moreover, since enough teachings of the coils 420B and 420C of FIG. 4B and FIG. 4C can be learned from the descriptions provided in the embodiment of the coil 420A, detailed description thereof would not be repeated.

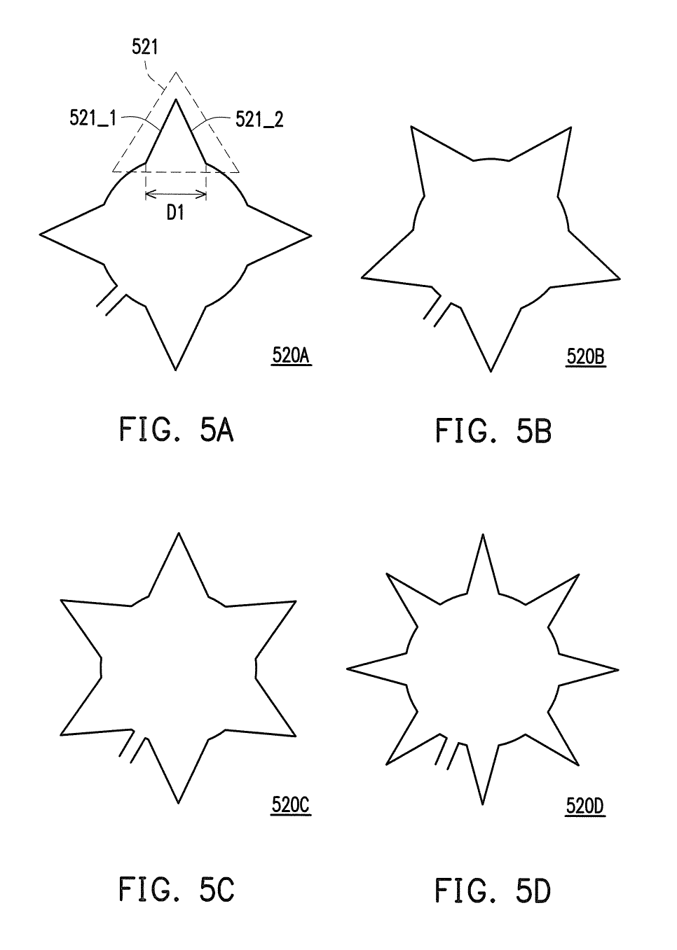

Moreover, in the embodiment, the bending pattern of the bending sections of the disclosure is not limited to the coil structures shown in FIG. 2 and FIG. 3. The bending pattern of the bending sections provided in the embodiment may have different designs according to an actual requirement. For example, FIG. 5A to FIG. 5D are schematic diagrams illustrating coils with different number of leaf-shaped bending sections according to an embodiment of the disclosure, as a leaf-shaped manner for the bending pattern of the bending sections. In FIG. 5A to FIG. 5D, the coils 520A-520D respectively have four, five, six, and eight bending sections, where the bending sections all have a bending pattern of the same leaf-shaped pattern, so the coils 520A-520D can provide more evenly magnetic field strength than traditional round coils in the region encircled by the coils, so as to provide good wireless transmission efficiency.

Referring to FIG. 5A, in the embodiment, the coil 520A has four bending sections, and each of the bending sections has the same leaf-shaped bending pattern. In an embodiment, the bending section 521 has a fourth section 521_1 and a fifth section 521_2, where the fourth section 521_1 and the fifth section 521_2 are connected at one end, or connected to one section, and there exists a distance D1 between the other ends of section 521_1 and 521_2; the length of the section which connects 521_1 and 521_2 is smaller than the distance D1, which is not limited by the disclosure. Pattern characteristics of the other bending sections of the coil 520A are similar to those of the bending section 521. Moreover, since enough teachings of the coils 520B, 520C and 520D illustrated in FIG. 5B to FIG. 5D can be learned from the descriptions provided in the embodiment of the coil 520A, detailed description thereof would not be repeated.

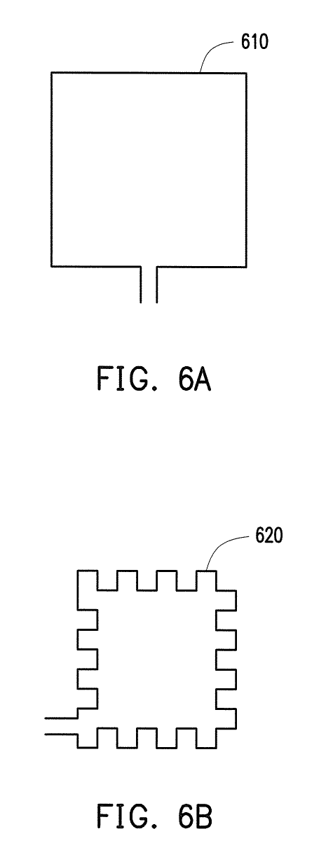

FIG. 6A and FIG. 6B are schematic diagrams of coils with a rectangular pattern and a serrated pattern according to another embodiment of the disclosure. In the embodiment, a coil pattern of a fifth coil 610 can be a rectangle, and a corresponding sixth coil 620 may include a plurality of bending sections, where the bending sections are respectively disposed along a rectangular track for corresponding to the rectangular coil pattern of the fifth coil 610. Moreover, the bending sections include a plurality of bending patterns, and these bending patterns are, for example, curved lines or straight lines and are arranged in a serrated manner. The numbers of the bending sections and the bending patterns provided the embodiment may have various variations and designs and are not limited to those shown in FIG. 6A and FIG. 6B.

In the embodiment, the coil pattern of the fifth coil 610 can be a rectangle, and the corresponding sixth coil 620 includes a plurality of bending sections having a plurality of serrated patterns. The sixth coil 620 may provide a magnetic field with the evenly distributed strength at the coil center through the bending sections extending to the coil center, or provide a magnetic field with the evenly distributed strength at the periphery of the coil through the periodically varied bending sections. Therefore, the energy transmission between the fifth coil 610 and the sixth coil 620 through inductive coupling may have a good efficiency.

Moreover, since enough teachings of various coil variations and application combinations of the fifth coil 610 and the sixth coil 620 can be learned from the descriptions provided in the aforementioned embodiments, detailed description thereof would not be repeated.

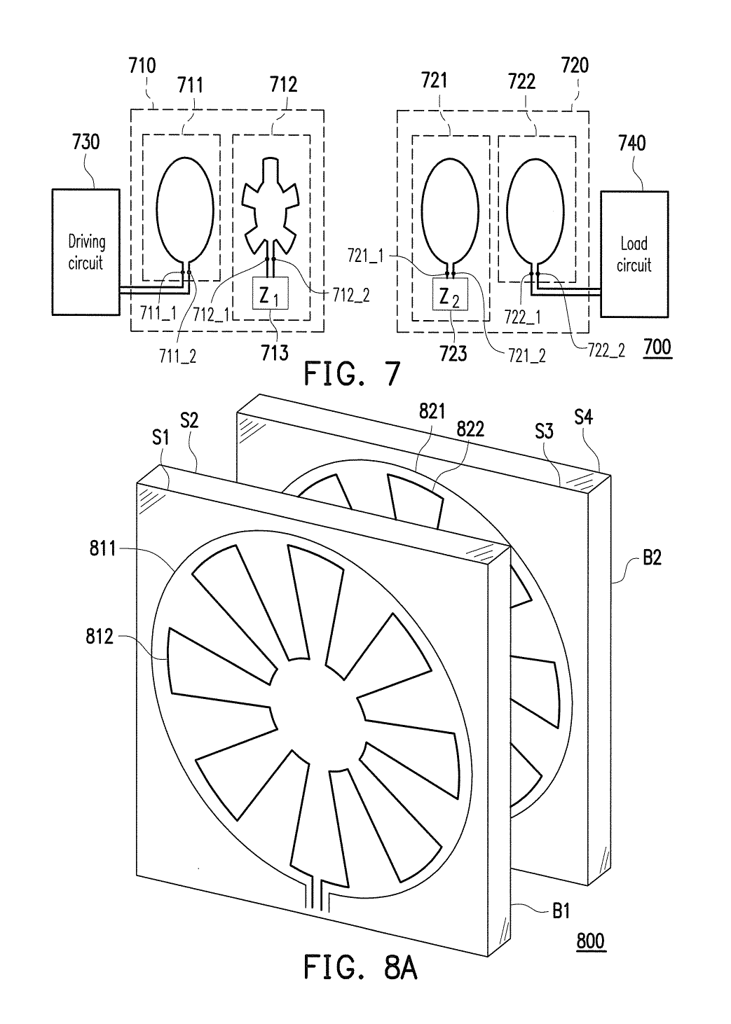

FIG. 7 is a schematic diagram of a wireless power transmission system according to an embodiment of the disclosure. The wireless power transmission system 700 includes a first coil assembly 710 and a second coil assembly 720. The first coil assembly 710 and the second coil assembly 720 resonate at a certain frequency point, such that the first coil assembly 710 may effectively transmit energy to the second coil assembly 720. The first coil assembly 710 includes a seventh coil 711 and an eighth coil 712, where the seventh coil 711 is connected to a driving circuit 730 and is inductively coupled to the eighth coil 712. The eighth coil 712 is connected to an impedance element 713 configured to adjust the frequency of the resonance, and transmits energy to the second coil assembly 720. The second coil assembly 720 includes a ninth coil 721 and a tenth coil 722, where the tenth coil 722 is connected to a load circuit 740 and is inductively coupled to the ninth coil 721. The ninth coil 721 is connected to an impedance element 723 configured to adjust the frequency of the resonance, and receives energy emitted from the first coil assembly 710. In the embodiment, the impedance elements 713 and 723 can be resistors, capacitors, inductors, or a combination thereof, which is not limited by the disclosure. In embodiments of the disclosure, each of the coils has two contacts which can be connected to the driving circuit, the impedance element, or the load circuit, etc. For example, the seventh coil 711 of FIG. 7 is connected to the driving circuit 730 through contacts 711_1 and 711_2, the eighth coil 712 is connected to the impedance element 713 through contacts 712_1 and 712_2, the ninth coil 721 is connected to the impedance element 723 through contacts 721_1 and 721_2, and the tenth coil 722 is connected to the load circuit 740 through contacts 722_1 and 722_2.

In the embodiment, the first coil assembly 710 may serve as a transmitting end of the wireless power transmission system 700. The first coil assembly 710 is configured to transmit energy (for example, an alternating current (AC)) of the driving circuit 730 to the second coil assembly 720 in a magnetic field resonance manner. The second coil assembly 720 may serve as a receiving end of the wireless power transmission system 700. The second coil assembly 720 is configured to receive energy emitted from the first coil assembly 710 and transfer the energy to the load circuit 740. In the embodiment, the eighth coil 712 has a coil structure with a plurality of bending sections. The eighth coil 712 may provide an evenly distributed magnetic field strength in its encircled region through the sections which extend to the center of the coil; therefore the efficiency of wireless power transmission is improved. In the embodiment, at least one of the seventh coil 711, the eighth coil 712, the ninth coil 721, and the tenth coil 722 can be have coil structure with the plurality of bending sections, which is not limited by the disclosure.

Since enough teachings have been revealed, variations in coil patterns, variations in the number of coils, and application combinations of each of the coils in the first coil assembly 710 and the second coil assembly 720 can be derived from the descriptions of the aforementioned embodiments. Detailed description thereof would not be repeated.

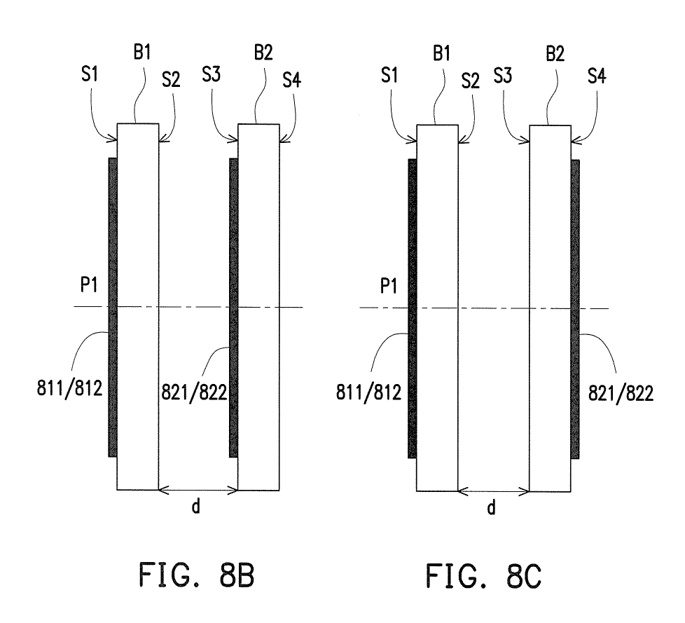

FIG. 8A to FIG. 8C are schematic diagrams illustrating configurations of coils of a wireless power transmission system according to an embodiment of the disclosure. Referring to FIG. 8A, a first substrate B1 has a first plane S1 and a second plane S2, and a second substrate B2 has a third plane S3 and a fourth plane S4. In the embodiment, the wireless power transmission system 800 includes a third coil assembly (for example, a coil combination on the first plane S1 of the first substrate B1), and a fourth coil assembly (for example, a coil combination on the third plane S3 of the second substrate B2, and a predetermined position thereof is shown in solid lines). The third coil assembly includes an eleventh coil 811 and a twelfth coil 812 disposed on the first plane S1 of the first substrate B1. The fourth coil assembly includes a thirteenth coil 821 and a fourteenth coil 822 disposed on the third plane S3 of the second substrate B2. In the embodiment, the first substrate B1 is parallel to the second substrate B2, and the first coil assembly and the second coil assembly are substantially spaced apart by a distance and transmit energy in a wireless manner.

For example, FIG. 8B is a side view of the wireless power transmission system of FIG. 8A according to an embodiment of the disclosure. In the embodiment, the eleventh coil 811 and the twelfth coil 812 of the third coil assembly are disposed on the first plane S1 of the first substrate B1, and the thirteenth coil 821 and the fourteenth coil 822 of the fourth coil assembly are disposed on the third plane S3 of the second substrate B2 at the same side. The first substrate B1 and the second substrate B2 are spaced apart by a distance d.

For another example, FIG. 8C is a side view of the wireless power transmission system illustrated in FIG. 8A according to another embodiment of the disclosure. In the embodiment, the eleventh coil 811 and the twelfth coil 812 of the third coil assembly are disposed on the first plane S1 of the first substrate B1, and the thirteenth coil 821 and the fourteenth coil 822 of the fourth coil assembly are disposed on the fourth plane S4 of the second substrate B2 at the opposite side. The first substrate B1 and the second substrate B2 are spaced apart by a distance d.

The third coil assembly and the fourth coil assembly of the wireless power transmission system shown in FIG. 8A to FIG. 8C can be selectively disposed on the same side or different sides of the first substrate B1 and the second substrate B2 according to different designs of the wireless power transmission system. Moreover, in the aforementioned embodiments, the distance d between the first substrate B1 and the second substrate B2 can be designed according to an actual requirement, or the distance d between the first substrate B1 and the second substrate B2 is determined according to coil sizes of the third coil assembly and the fourth coil assembly, which is not limited by the disclosure.

In the embodiment, the first substrate B1 and the second substrate B2 can be any carrier medium or material that is suitable for setting the coils, such as a printed circuit board (PCB), a flexible printed circuit board (FPC), an integrated circuit board (thin-film), etc., and a thickness of the substrate can be designed according to different coil sizes, materials, magnetic coupling ranges, etc., which is not limited by the disclosure. Moreover, in the embodiment, the eleventh coil 811 and the twelfth coil 812 can also be respectively disposed on the different planes of the first substrate B1, for example, respectively on the first plane S1 and the second plane S2 of the first substrate B1, and the thirteenth coil 821 and the fourteenth coil 822 can also be respectively disposed on the third plane S3 and the fourth plane S4 of the second substrate B2, which is not limited to the implementations shown in FIG. 8B and FIG. 8C. In the embodiment, one may refer to descriptions provided in the embodiments shown in FIG. 2A-FIG. 2C and FIG. 3 to learn the combination of the configuration positions of each of the coils, and details thereof would not be repeated.

In the embodiment of FIG. 8A, the third coil assembly and the fourth coil assembly may transmit energy therebetween through magnetic field resonance, and the coil sizes of the third coil assembly and the fourth coil assembly can be the same. The third coil assembly and the fourth coil assembly are, for example, disposed in parallel and are spaced apart by a distance. The twelfth coil 812 and the fourteenth coil 822 may respectively include a plurality of bending sections, so as to provide a magnetic field with the evenly distributed strength through the bending sections extending to the coil center. In this way, the magnetic field resonance between the third coil assembly and the fourth coil assembly may have good energy transmission efficiency. Moreover, the distance between the third coil assembly and the fourth coil assembly can be designed according to an actual requirement, or the distance between the third coil assembly and the fourth coil assembly can be determined according to sizes of the third coil assembly and the fourth coil assembly, which is not limited by the disclosure.

Since enough teachings have been revealed, variations in coil patterns, variations in the number of coils, and application combinations of each of the coils in the third coil assembly and the fourth coil assembly can be derived from the descriptions of the aforementioned embodiments. Detailed description thereof would not be repeated.

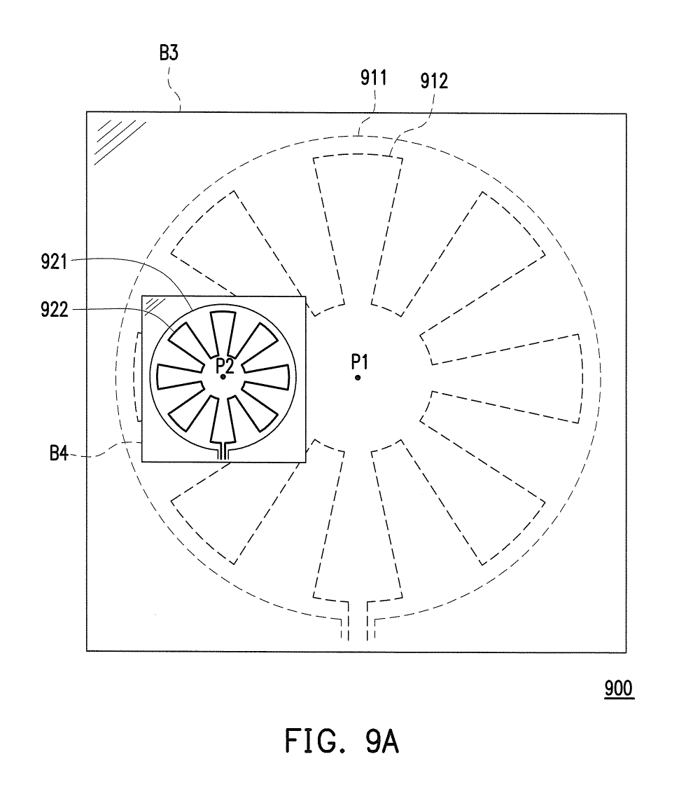

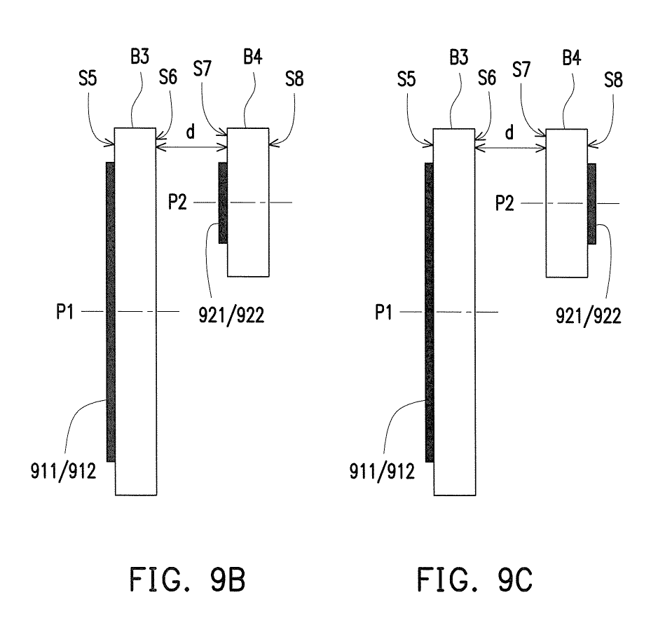

FIG. 9A to FIG. 9C are schematic diagrams illustrating configurations of coils of a wireless power transmission system according to another embodiment of the disclosure. Referring to FIG. 9A, the wireless power transmission system 900 includes a fifth coil assembly (for example, a coil combination on a third substrate B3), and a sixth coil assembly (for example, a coil combination on a fourth substrate B3, and a predetermined position thereof is shown in dot lines). The fifth coil assembly includes a fifteenth coil 911 and a sixteenth coil 912. The sixth coil assembly includes a seventeenth coil 921 and an eighteenth coil 922. The fifth coil assembly and the sixth coil assembly can be disposed on different planes parallel to each other without coinciding with each other. In the embodiment, the distance from any point on the fifteenth coil 911 or the sixteenth coil 912 to the central axis P1 of the fifth coil assembly is greater than the distance from any point on the seventeenth coil 921 or the eighteenth coil 922 to the central axis P2 of the sixth coil assembly, where the central axes P1 and P2 are respectively perpendicular to the planes of the third substrate B3 and the fourth substrate B4. Moreover, the fifth coil assembly and the sixth coil assembly of the wireless power transmission system 900 are respectively disposed on two different substrates (not shown), the two substrates are spaced apart by a distance (not shown), and one may refer to the embodiment shown in FIG. 8A to learn the substrate characteristics, which would not be repeated.

A difference between FIG. 9A and FIG. 8A is that the wireless power transmission system 800 shown in FIG. 8A has the third coil assembly and the fourth coil assembly with the same size and the same central axis, though the wireless power transmission system 900 shown in FIG. 9A has the fifth coil assembly and the sixth coil assembly with different sizes and different central axes; for example, the sixth coil assembly of the wireless power transmission system 900 of FIG. 9A can be disposed at any position within a coil range or a magnetic coupling range of the fifth coil assembly, where the central axis P1 of the fifth coil assembly and the central axis P2 of the sixth coil assembly can be misaligned or coincided, which is not limited to the disclosure.

For example, FIG. 9B is a side view of the wireless power transmission system shown in FIG. 9A according to an embodiment of the disclosure. In the embodiment, the third substrate B3 has a fifth plane S5 and a sixth plane S6, and the fourth substrate B4 has a seventh plane S7 and an eighth plane S8. The fifteenth coil 911 and the sixteenth coil 912 of the fifth coil assembly are disposed on the fifth plane S5 of the third substrate B3, and the seventeenth coil 921 and the eighteenth coil 922 of the sixth coil assembly are disposed on the seventh plane S7 of the fourth substrate B4 at the same side. The substrate B3 and the fourth substrate B4 are spaced apart by a distance d. In the embodiment, the fifth coil assembly and the sixth coil assembly have different coil sizes, and the central axis P1 of the fifth coil assembly and the central axis P2 of the sixth coil assembly can be coincided or not coincided with each other.

For another example, FIG. 9C is a side view of the wireless power transmission system of FIG. 9A according to another embodiment of the disclosure. In the embodiment, the third substrate B3 has the fifth plane S5 and the sixth plane S6, and the fourth substrate B4 has the seventh plane S7 and the eighth plane S8. The fifteenth coil 911 and the sixteenth coil 912 of the fifth coil assembly are disposed on the fifth plane S5 of the third substrate B3, and the seventeenth coil 921 and the eighteenth coil 922 of the sixth coil assembly are disposed on the eighth plane S8 of the fourth substrate B4 at the opposite side. The substrate B3 and the fourth substrate B4 are spaced apart by the distance d. In the embodiment, the fifth coil assembly and the sixth coil assembly have different coil sizes, and the central axis P1 of the fifth coil assembly and the central axis P2 of the sixth coil assembly can be coincided or not coincided with each other.

The fifth coil assembly and the sixth coil assembly of the wireless power transmission system shown in FIG. 9B and FIG. 9C can be selectively disposed on the planes of the third substrates B3 and the fourth substrate B4 at the same side or different sides according to different designs of the wireless power transmission system or different usage requirements. Moreover, since the fifth coil assembly and the sixth coil assembly shown in FIG. 9B and FIG. 9C may have different coil sizes, a relative position between the fifth coil assembly disposed on the third substrate B3 and the sixth coil assembly disposed on the fourth substrate B4 can be determined according to different designs of the wireless power transmission system or a magnetic coupling range, which is not limited to the disclosure.

Referring to FIG. 9A, in the embodiment the fifth coil assembly and the sixth coil assembly transmit energy therebetween through magnetic field resonance. The fifth coil assembly and the sixth coil assembly are, for example, disposed in parallel and are spaced apart by a distance. Since the coil sizes of the fifth coil assembly and the sixth coil assembly can be different, for example, an area ratio of the fifth coil assembly to the sixth coil assembly shown in FIG. 9A is 9:1, a coil coverage range of the fifteenth coil 911 and the sixteenth coil 912 can be greater than that of the seventeenth coil 921 and the eighteenth coil 922. In this way, the fifteenth coil 911 and the sixteenth coil 912 may serve as a transmitting end of the wireless power transmission system, and the seventeenth coil 921 and the eighteenth coil 922 may serve as a receiving end of the wireless power transmission system. According to the aforementioned descriptions, the fifteenth coil 911 and the sixteenth coil 912 of the fifth coil assembly can provide an evenly distributed magnetic field strength in its encircled area. Moreover, the area of the fifth coil assembly is greater than the sixth coil assembly. In this way, regardless of the position of the seventeenth coil 921 and the eighteenth coil 922 relative to the fifth coil assembly, good energy transmission efficiency is achieved. In the embodiment, the sixteenth coil 912 and the eighteenth coil 922 may respectively include a plurality of bending sections extending to the coil center for providing a magnetic field in which the strength is evenly distributed. Therefore, the magnetic field resonance between the fifth coil assembly and the sixth coil assembly may result in good energy transmission efficiency. Moreover, in the embodiment, the ratio of the coil sizes of the fifth coil assembly and the sixth coil assembly can be designed and varied according to an actual requirement, and the distance between the fifth coil assembly and the sixth coil assembly can be determined according to the coil sizes of the fifth coil assembly and the sixth coil assembly, which is not limited to the disclosure.

Since enough teachings have been revealed, variations in coil patterns, variations in the number of coils, and application combinations of each of the coils in the fifth coil assembly and the sixth coil assembly can be derived from the descriptions of the aforementioned embodiments. Detailed description thereof would not be repeated.

In summary, the embodiments of the disclosure provide a coil assembly and a wireless power transmission system, and the coil assembly of the wireless power transmission system may include a plurality of coils having a plurality of bending sections with various bending patterns extending to the coil center, in order to provide a magnetic field in which the strength is evenly distributed. In this way, the magnetic field with the evenly distributed strength can improve the efficiency of wireless power transmission of the wireless power transmission system. On the other hand, based on a pattern design and a quantity design of the bending sections of the coil structure, the coil assembly or the wireless power transmission system may provide good wireless power transmission efficiency according to different user requirements. Moreover, by changing configuration positions and sizes of the coils, the disclosure may provide diversified electromagnetic induction variations and applications.

It will be apparent to those skilled in the art that various modifications and variations can be made to the structure of the disclosure without departing from the scope or spirit of the disclosure. In view of the foregoing, it is intended that the disclosure covers modifications and variations of this disclosure provided they fall within the scope of the following claims and their equivalents.

What is claimed is:

1. A coil assembly, comprising:
a first coil, disposed on a first plane; and
a second coil, disposed on a second plane, and coupled to the first coil,
wherein the second coil comprises a plurality of bending sections, and the bending sections are connected by a plurality of connection lines to form a single loop.

2. The coil assembly as claimed in claim 1, wherein the first coil is connected to a driving circuit, and the first coil is coupled to the second coil for transmitting energy to the second coil.

3. The coil assembly as claimed in claim 1, wherein the second coil is connected to a driving circuit, and the second coil is coupled to the first coil for transmitting energy to the first coil.

4. The coil assembly as claimed in claim 1, wherein the first coil is connected to a load circuit, and the first coil is coupled to the second coil for receiving energy from the second coil.

5. The coil assembly as claimed in claim 1, wherein the second coil is connected to a load circuit, and the second coil is coupled to the first coil for receiving energy from the first coil.

6. The coil assembly as claimed in claim 1, wherein the first plane is coincident with the second plane, the first coil and the second coil have a same first central axis, and a distance between any point on the first coil and the first central axis is greater than a distance between any point on the second coil and the first central axis, wherein the first central axis is perpendicular to the first plane and the second plane.

7. The coil assembly as claimed in claim 1, wherein the first plane is not coincident with the second plane, and the first coil and the second coil have a same first central axis, wherein the first central axis is perpendicular to the first plane and the second plane.

8. The coil assembly as claimed in claim 1, wherein a coil pattern of the first coil is round or rectangular.

9. The coil assembly as claimed in claim 1, wherein the bending sections of the second coil are disposed along a round track, and each of the bending sections comprises a plurality of bending patterns, wherein the bending patterns are straight lines or curved lines, and the bending patterns are arranged in a fan-shaped manner or a leaf-shaped manner.

10. The coil assembly as claimed in claim 1, wherein the bending sections of the second coil are disposed along a rectangular track, and each of the bending sections comprises a plurality of bending patterns, wherein the bending patterns are straight lines or curved lines, and the bending patterns are arranged in a serrated manner.

11. A wireless power transmission system, comprising:
a first coil assembly, comprising a first coil and a second coil; and
a second coil assembly, comprising a third coil and a fourth coil, the first coil assembly being coupled to the second coil assembly,
wherein at least one of the second coil and the third coil comprises a plurality of bending sections, and the bending sections are connected by a plurality of connection lines to form a single loop.

12. The wireless power transmission system as claimed in claim 11, wherein the first coil assembly is connected to a driving circuit, and is coupled to the second coil assembly for transmitting energy from the first coil assembly to the second coil assembly.

13. The wireless power transmission system as claimed in claim 12, wherein the first coil is connected to a driving circuit.

14. The wireless power transmission system as claimed in claim 13, wherein the second coil is connected to an impedance element.

15. The wireless power transmission system as claimed in claim 12, wherein the third coil is connected to an impedance element.

16. The wireless power transmission system as claimed in claim 15, wherein the fourth coil is connected to a load circuit.

17. The wireless power transmission system as claimed in claim 11, wherein the first coil assembly is parallel to the second coil assembly, and the first coil assembly and the second coil assembly resonate to transmit energy to the second coil assembly.

18. The wireless power transmission system as claimed in claim 11, wherein a distance from any point on the first coil or the second coil to first central axis of the first coil assembly is greater than or equal to a distance from any point on the third coil or the fourth coil to second central axis of the second coil assembly.

19. The wireless power transmission system as claimed in claim 11, wherein a coil pattern of at least one of the first coil and the third coil is round or rectangular.

20. The wireless power transmission system as claimed in claim 11, wherein the bending sections of at least one of the second coil and the third coil are disposed along a round track, and each of the bending sections comprises a plurality of bending patterns, wherein the bending patterns are straight lines or curved lines, and the bending patterns are arranged in a fan-shaped manner or a leaf-shaped manner.

21. The wireless power transmission system as claimed in claim 11, wherein the bending sections of at least one of the second coil and the third coil are disposed along a rectangular track, and each of the bending sections comprises a plurality of bending patterns, wherein the bending patterns are straight lines or curved lines, and the bending patterns are arranged in a serrated manner.
